(19) United States
(12) Patent Application Publication
(10) Pub. No.: US 2015/0114366 A1
(43) Pub. Date: Apr. 30, 2015

(54) SYSTEMS AND METHODS FOR IMPLEMENTING AN OPEN THERMODYNAMIC CYCLE FOR EXTRACTING ENERGY FROM A GAS

(71) Applicant: The Ohio State University, Columbus, OH (US)

(72) Inventors: Codrin-Gruie Cantemir, Columbus, OH (US); Fabio Chiara, Columbus, OH (US); Marcello Canova, Columbus, OH (US)

(21) Appl. No.: 14/390,911

(22) PCT Filed: Mar. 15, 2013
(86) PCT No.: PCT/US2013/032285

§ 371 Date: Oct. 6, 2014

Related U.S. Application Data
(60) Provisional application No. 61/709,315, filed on Oct. 3, 2012.
(60) Provisional application No. 61/620,476, filed on Apr. 5, 2012.

(51) Int. Cl. F01N 5/02; F02B 37/00; F02M 25/07

(52) U.S. Cl. CPC F01N 5/02; F02M 25/0706; F02M 25/0726; F02B 37/005
USPC 123/568.12; 60/320; 60/615; 60/605.2

(57) ABSTRACT

Systems and method for extracting energy from a gas are disclosed herein. In particular, systems and methods for implementing a series of thermodynamic transformations by means of which it is possible to extract useful work from a gas carrying thermal energy due its thermodynamic state are disclosed. An example system for extracting energy from a cycle gas can include an expander for expanding the cycle gas, a heat exchanger in fluid connection with the expander for cooling the expanded cycle gas while maintaining the expanded cycle gas at an approximately constant pressure, and a compressor in fluid connection with the heat exchanger for compressing the cooled cycle gas.

### CROSS-REFERENCE TO RELATED APPLICATIONS

This application claims the benefit of U.S. Provisional Patent Application No. 61/620,476, filed on Apr. 5, 2012, entitled “Open Thermodynamic Cycle for Waste Heat Recovery (3C Cycle),” and U.S. Provisional Patent Application No. 61/709,315, filed on Oct. 3, 2012, entitled “Application of the 3C Cycle to the EGR Loop of a Combustion Engine,” the disclosures of which are expressly incorporated herein by reference in their entireties.

### BACKGROUND

Exhaust gas carries thermal energy due to its thermodynamic state. Exhaust gas can be a by-product of a number of devices or systems such as internal combustion engines, for instance, and is oftentimes discharged to the surrounding environment without recovering the thermal energy. Additionally, exhaust gas is recirculated from an exhaust manifold to an intake manifold of the internal combustion engine. However, the thermal energy is not used to produce useful work. Thus, the thermal energy carried by exhaust gas is wasted. In some cases, the thermal energy is extract from exhaust gas but the amount of energy extracted has been limited.

### SUMMARY

Systems and method for extracting energy from a gas are disclosed herein. In particular, systems and methods for implementing a series of thermodynamic transformations by means of which it is possible to extract useful work from a gas carrying thermal energy due its thermodynamic state are disclosed. An example system for extracting energy from a cycle gas can include an expander for expanding the cycle gas, a heat exchanger in fluid connection with the expander for cooling the expanded cycle gas while maintaining the expanded cycle gas at an approximately constant pressure and a compressor in fluid connection with the heat exchanger for compressing the cooled cycle gas. Optionally, the cycle gas can be expanded to a pressure less than ambient pressure, and the cooled cycle gas can be compressed to at least ambient pressure. Optionally, a pressure of the cycle gas before expansion is greater than ambient pressure.

The system can optionally include a common shaft, and the expander and the compressor can be mounted to the common shaft. Additionally, mechanical power generated by expanding the cycle gas can be greater than mechanical power needed to compress the cooled cycle gas.

Alternatively, the system can optionally include a first common shaft and an electric generator. The expander and the electric generator can be mounted to the first common shaft. Optionally, the system can include a power line in electrical communication with the electric generator for receiving electrical power. The system can optionally include a rectifier circuit for converting AC electrical power to DC electrical power. Additionally, the received electrical power can be DC electrical power. Alternatively or additionally, the system can optionally include a second common shaft and a motor, and the compressor and the motor can be mounted to the second common shaft. Optionally, the system can include a power line in electrical communication with the motor for supplying electrical power. The system can optionally include an inverter circuit for converting DC electrical power to AC electrical power. Additionally, the supplied electrical power can be DC electrical power. Electrical power generated by the electric generator can be greater than electrical power needed to power the motor. For example, net electrical power can be supplied to an external system.

Optionally, expansion and compression of the cycle gas can be polytropic or adiabatic processes. Further, the cycle gas can be a by-product exhaust gas of an upstream process. Alternatively or additionally, the expander can optionally be a turbine or a volumetric expander, and the heat exchanger can optionally be an air or liquid cooled heat exchanger.

An example method for extracting energy from a cycle gas can include expanding the cycle gas in an expander, cooling the expanded cycle gas in a heat exchanger while maintaining the expanded cycle gas at an approximately constant pressure and compressing the cooled cycle gas in a compressor. Optionally, the cycle gas can be expanded to a pressure less than ambient pressure, and the cooled cycle gas can be compressed to at least ambient pressure. Optionally, a pressure of the cycle gas before expansion is greater than ambient pressure.

The mechanical power generated by expanding the cycle gas can be greater than mechanical power needed to compress the cooled cycle gas. Optionally, the method can include driving an electric generator with the expander to produce electrical power. The method can also optionally include converting the electrical power to DC electrical power. Further, the method can include supplying the electrical power to a motor and driving the compressor with the motor. Optionally, the method can include converting DC electrical power to the electrical power. Electrical power generated by the electric generator can be greater than electrical power needed to power the motor.

An example system for extracting energy from an exhaust gas of an internal combustion engine is also provided. The internal combustion engine can include an intake manifold and an exhaust manifold. The system can include an expander in fluid connection with the exhaust manifold, and the expander can receive and expand at least a portion of the exhaust gas from the internal combustion engine. The system can also include a heat exchanger in fluid connection with the expander for cooling the expanded exhaust gas while maintaining the expanded exhaust gas at an approximately constant pressure and a compressor in fluid connection with the heat exchanger for compressing the cooled exhaust gas. Optionally, the expander can receive and expand at least a portion of the exhaust gas from the internal combustion engine to a pressure less than ambient pressure, and the cooled exhaust gas can be compressed to at least ambient pressure. Optionally, a pressure of the exhaust gas before expansion is greater than ambient pressure.

The system can also include a common shaft, and the expander and the compressor can be mounted to the common shaft. Additionally, mechanical power generated by expanding the exhaust gas can be greater than mechanical power needed to compress the cooled exhaust gas.

Alternatively, the system can include a first common shaft and an electric generator. The expander and the electric generator can be mounted to the first common shaft. Additionally, the system can include a second common shaft and a motor. The compressor and the motor can be mounted to the second common shaft. Electrical power generated by the electric generator can be greater than electrical power needed to power the motor. For example, net electrical power can be supplied to an external system.

Optionally, the compressor can be in fluid connection with the intake manifold. Additionally, the expanded exhaust gas can be cooled to a temperature required at the intake manifold. Optionally, the system can include an exhaust gas recirculation valve configured to regulate an amount of exhaust gas received by the expander. The exhaust gas recirculation valve can optionally be disposed between the exhaust gas manifold and the expander or between the expander and the heat exchanger or between the heat exchanger and the compressor or between the compressor and the intake manifold. A ratio of the compressed exhaust gas to total intake gas at the intake manifold can be a predetermined ratio required by the internal combustion engine. For example, the predetermined ratio can be approximately 80%.

Optionally, a turbocharger can be connected between the intake manifold and the exhaust manifold of the internal combustion engine. At least a portion of the exhaust gas can be received by the expander and the turbocharger.

An example vehicle can include an internal combustion engine and an exhaust gas recirculation system is also provided. The internal combustion engine can have an intake manifold and an exhaust manifold. Additionally, the exhaust gas recirculation system can include an expander in fluid connection with the exhaust manifold, and the expander can receive and expand at least a portion of the exhaust gas from the internal combustion engine. The exhaust gas recirculation system can also include a heat exchanger in fluid connection with the expander for cooling the expanded exhaust gas while maintaining the expanded exhaust gas at an approximately constant pressure and a compressor in fluid connection with the heat exchanger for compressing the cooled exhaust gas. Optionally, the exhaust gas can be expanded to a pressure less than ambient pressure, and the cooled exhaust gas can be compressed to at least ambient pressure. In addition, the compressor can be in fluid connection with the intake manifold, and the compressed exhaust gas can be discharged to the intake manifold.

Optionally, the vehicle can include a turbocharger connected between the intake manifold and the exhaust manifold of the internal combustion engine. At least a portion of the exhaust gas can be received by the expander and the turbocharger.

An example method for recirculating exhaust gas from an internal combustion engine can include receiving exhaust gas at an exhaust gas manifold of the internal combustion engine, diverting at least a portion of the exhaust gas to an energy extraction system, extracting energy from the diverted exhaust gas and returning the diverted exhaust gas to an intake manifold of the internal combustion engine. A ratio of the returned exhaust gas to total intake gas at the intake manifold can be a predetermined ratio required by the internal combustion engine. For example, the predetermined ratio can be approximately 80%.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A is an ideal temperature-entropy (T-S) diagram illustrating an open thermodynamic cycle for recovering energy from a gas;

FIG. 1B is an ideal pressure-volume (P-V) diagram illustrating an open thermodynamic cycle for recovering energy from a gas;

FIGS. 2A-2B are block diagrams of example systems for recovering energy from a gas;

FIG. 3 is a block diagram of an internal combustion engine with a system for waste heat recovery in an exhaust gas recirculation (EGR) loop;

FIGS. 4A-4B are diagrams illustrating sensitivity analyses of varying expander outlet pressure on various system parameters; and

FIGS. 5A-5B are diagrams illustrating sensitivity analyses of varying expander inlet pressure on various system parameters.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. While implementations will be described for extracting energy from an exhaust gas, it will become evident to those skilled in the art that the implementations are not limited thereto, but are applicable for extracting energy from any gas carrying thermal energy due to its thermodynamic state (e.g., a by-product of an upstream process, a hot gas developed on purpose, etc.).

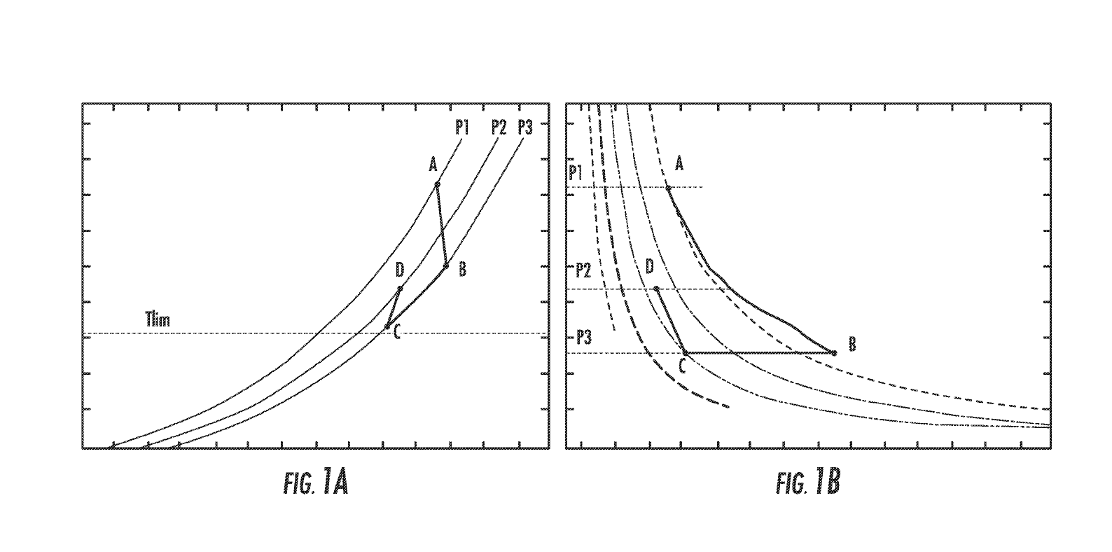

Referring now to FIGS. 1A-1B, an open thermodynamic cycle for recovering energy from a gas are described with reference to T-S and P-V diagrams, respectively. By means of the thermodynamic transformation shown in FIGS. 1A-1B, it is possible to extract useful work from a gas carrying thermal energy due its thermodynamic state, for example. The thermal energy can be carried by a gas (hereinafter a “cycle gas” or an “exhaust gas”) which can be, but is not limited to, internal combustion engine exhaust gas, furnace gas and any other hot gas coming as by-product of another upstream process or developed on purpose, for example, by means of a burner.

As shown in FIGS. 1A-1B, the cycle gas is expanded. This is shown by the line segment between point A and point B. The cycle gas can undergo thermodynamic process A→B starting from an initial pressure sufficiently greater than atmospheric pressure (or ambient pressure) (e.g., P1) and ending at a pressure less than the initial pressure (e.g., P3). The end pressure can be a low as technologically practical (e.g., a pressure difference sufficient such that energy can be extracted during the expansion). For example, the end pressure can optionally be sufficiently less than atmospheric pressure. In other words, the cycle gas can be over-expanded below atmospheric pressure. For example, the cycle gas can enter an expander inlet at approximately P1=1.2 bar and exit the expander outlet at approximately P3=0.5 bar. Alternatively, the end pressure can optionally be greater than atmospheric pressure (but less than the initial pressure). It should be understood that these pressure values are provided only as examples. Thermodynamic process A→B can be performed in one or more expanders including, but not limited to, centripetal turbines and volumetric expanders. The expansion process can collect useful mechanical work on a shaft of the expander. Optionally, thermodynamic process A→B can be a polytropic thermodynamic process. Optionally, thermodynamic process A→B can be an adiabatic thermodynamic process.

Next, the cycle gas is cooled. This is shown by the line segment between point B and point C. The cycle gas can undergo thermodynamic process B→C starting from an initial temperature of the gas in the expander and ending at a minimum temperature of the cycle gas (e.g., Tlim). For example, the cycle gas can be cooled in a heat exchanger to reduce the temperature of the cycle gas. Thermodynamic process B→C can be performed in one or more heat exchangers. The heat exchangers can include, but are not limited to, liquid or air cooled heat exchangers. The heat exchangers can have a plurality of configurations including, but not limited to, counter-flow and cross-flow configurations. Additionally, thermodynamic process B→C can be an isobaric thermodynamic process. In other words, the cycle gas can be cooled while maintaining the cycle gas at an approximately constant pressure.

Next, the cycle gas is compressed. This is shown by the line segment between point C and point D. The cycle gas can undergo thermodynamic process C→D starting from an initial pressure at the compressor inlet (e.g., P3) and ending at a pressure greater than the initial pressure (e.g., P2). Optionally, the initial pressure at the compressor inlet can be sufficiently less than atmospheric pressure and the ending pressure can be approximately atmospheric pressure. For example, the cycle gas can enter a compressor inlet at approximately P3=0.5 bar and exit the compressor outlet at approximately P2=1.0 bar. It should be understood that these pressure values are provided only as examples. Thermodynamic process C→D can be performed in one or more compressors including, but not limited to, rotary, reciprocating, centripetal and axial compressors. The compression process can require expenditure of energy, but the energy required to compress the lower pressure, lower temperature cycle gas in the compressor is less than the energy extracted from the higher pressure, higher temperature cycle gas in the expander. Optionally, thermodynamic process C→D can be a polytropic thermodynamic process. Optionally, thermodynamic process C→D can be an adiabatic thermodynamic process. In addition, the cycle gas can optionally be discharged to atmosphere with its thermodynamic state at point D.

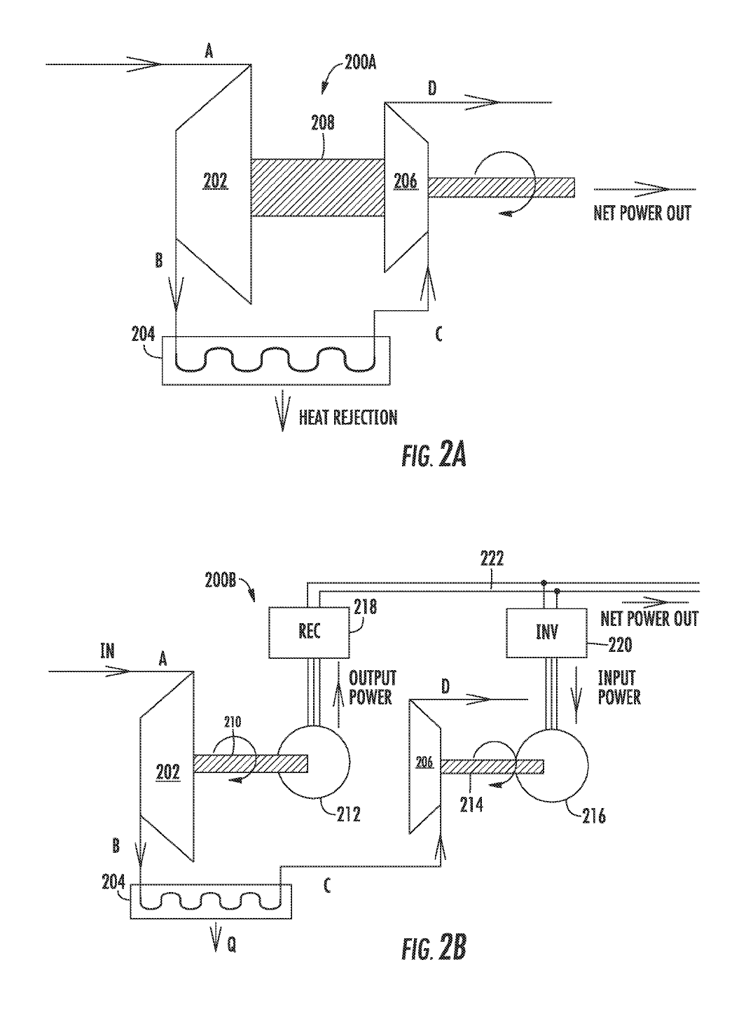

Referring now to FIG. 2A, a block diagram of an example system 200A for recovering energy from a gas is shown. Points A-D of the thermodynamic process discussed above with regard to FIGS. 1A-1B are also shown in FIG. 2A. The system 200A can include an expander 202, a heat exchanger 204 and a compressor 206. The expander 202 can be a centripetal turbine or volumetric expander, for example. Alternatively or additionally, the heat exchanger 204 can be an air or liquid cooled heat exchanger with a counter-flow or cross-flow configuration. Further, the compressor 206 can be a rotary, reciprocating, centripetal or axial compressor. It should be understood that the system 200A is provided only as an example and that systems having other configurations can be designed to extract energy from a gas according to the implementations discussed herein.

As discussed above, the cycle gas can be a gas carrying thermal energy due its thermodynamic state such as an exhaust gas, for example. The cycle gas enters an inlet of the expander at point A and undergoes thermodynamic process A→B. For example, the cycle gas is expanded from an initial pressure sufficiently above atmospheric pressure to a lesser pressure, which can optionally be a pressure sufficiently below atmospheric pressure. By thermodynamic process A→B, useful work can be collected on a shaft 208 of the expander. Additionally, this useful work can optionally include energy extracted from the cycle gas below atmospheric pressure. Accordingly, energy can optionally be recovered from the cycle gas under atmospheric pressure. Optionally, the cycle gas undergoes an adiabatic or polytropic expansion process.

The heat exchanger 204 can be in fluid connection with the expander 202. The cycle gas exits an outlet of the expander 202 and enters an inlet of the heat exchanger 204 at point B. The cycle gas then undergoes thermodynamic process B→C. For example, the cycle gas is cooled to a minimum temperature. In other words, heat is rejected during thermodynamic process B→C. Optionally, the cycle gas undergoes an isobaric cooling process. In other words, the cycle gas is maintained at an approximately constant pressure during the cooling process.

The compressor 206 can be in fluid connection with the heat exchanger 204. Optionally, the compressor 206 and the expander 204 can be mounted to a common shaft (e.g., the shaft 208). The cycle gas exits an outlet of the heat exchanger 204 and enters an inlet of the compressor 206 at point C. The cycle gas then undergoes thermodynamic process C→D. For example, the cycle gas is compressed from an initial pressure to a greater pressure. Optionally, the initial pressure can be sufficiently less than atmospheric pressure and the ending pressure can be approximately atmospheric pressure. Optionally, the cycle gas undergoes an adiabatic or polytropic compression process.

As shown in FIG. 2A, the expander 202 and the compressor 206 are mounted on the shaft 208 (e.g., a common shaft). As discussed above, energy is required to compress the cycle gas, but the lower pressure, lower temperature cycle gas requires less energy to compress than the energy extracted from the higher pressure, higher temperature cycle gas during the expansion process. The net power output of the system 200A is in mechanical form and is given by the difference between the mechanical power generated in the expander 202 and the mechanical power needed to perform the compression in the compressor 206. Additionally, it should be understood that accessory power is optionally used to flow external cooling fluid in the heat exchanger 204.

Referring now to FIG. 2B, a block diagram of another example system 200B for recovering energy from a gas is shown. Points A-D of the thermodynamic process discussed above with regard to FIGS. 1A-1B are also shown in FIG. 2B. Similar to FIG. 2A, the system 200B can include an expander 202, a heat exchanger 204 and a compressor 206. These components are the same or substantially similar to the components of FIG. 2A and are therefore not discussed in detail below. The system 200B can also include a first shaft 210, an electric generator 212, a second shaft 214 and a motor 216. It should be understood that the system 200B is provided only as an example and that systems having other configurations can be designed to extract energy from a gas according to the implementations discussed herein.

Also similar to FIG. 2A, the cycle gas undergoes thermodynamic process A→B in the expander 202, thermodynamic process B→C in the heat exchanger 204 and thermodynamic process CD in the compressor 206 of FIG. 2B. These thermodynamic processes are therefore not discussed in further detail below. In FIG. 2B, the expander 202 and the electric generator 212 are mounted to the first shaft 210, and the compressor 206 and the motor 216 are mounted to the second shaft 214. As discussed above, the expansion process can collect useful mechanical work on the first shaft 210. By means of the mechanical power generated by the expander 202, the electric generator 212 generates electrical power. In other words, the expander 202 drives the electric generator 212. The electric generator 212 can generate electrical power (e.g., AC or DC electrical power). The generated electrical power can be supplied to a power line 222. Optionally, the generated electrical power can be supplied to an external system via the power line 222. As shown in FIG. 2B, the electric generator 212 produces AC electrical power. Optionally, the system 200B can include a rectifier circuit 218 for converting AC electrical power to DC electrical power before supplying the electrical power to the power line 222. Rectifiers are well known in the art and are not discussed in further detail below.

Additionally, the motor 216 can drive the compressor 206. The motor 216 can optionally be an AC or DC electric motor. Optionally, the motor 216 can receive power from the power line 222. As shown in FIG. 2B, the motor is an AC motor, and the system 200B can optionally include an inverter circuit 220 for converting DC electrical power to AC electrical power. Inverters are well known in the art and are not discussed in further detail below. For example, as shown in FIG. 2B, DC electrical power is supplied via the power line 222, and the DC electrical power is converted to AC electrical power before being supplied to the motor 216. The motor 216 converts the electrical power into mechanical power allowing for the compressor 206 to rotate and compress the cycle gas. As discussed above, the energy extracted during the expansion process is greater than the energy required during the compression process. Thus, the net output power, in electrical form, is available on the power line 222 and is given by the difference between the electrical power generated by the electric generator 212 coupled to the expander 202 and the electrical power subtracted from the power line 222 by the motor 216 that actuates the compressor 206. Additionally, it should be understood that accessory power is optionally used to flow external cooling fluid in the heat exchanger 204. Although the system 200B is characterized by a number of devices, the independence between the power generation (in the expander 202) and the power subtraction (in the compressor 206) allows for a higher level of optimization and freedom of operation. Advantageously, this configuration does not require an additional starting device to begin the starting sequence, which is enabled by the cycle gas. Moreover, another advantage is that the electrical power available on the power line 222 can be practically used far from where the system 200B operates.

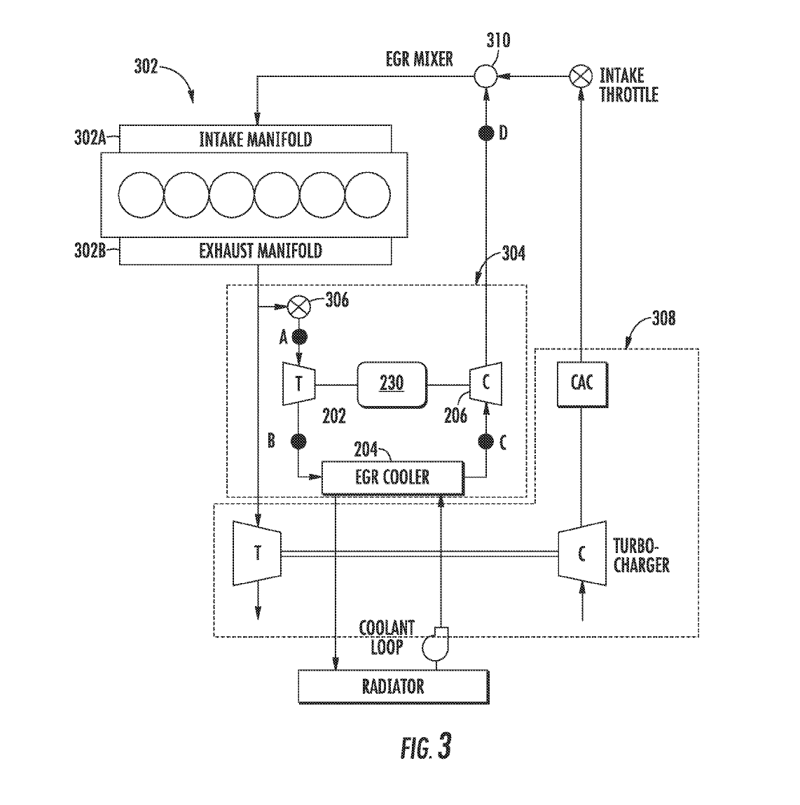

Referring now to FIG. 3, a block diagram of an internal combustion engine 302 with a system for waste heat recovery 304 in an exhaust gas recirculation (EGR) loop is shown. Points A-D of the thermodynamic process discussed above with regard to FIGS. 1A-1B are also shown in FIG. 3. The internal combustion engine 302 can optionally be provided in a vehicle, for example. Alternatively, the internal combustion engine 302 can be an engine for any type of device. Optionally, the internal combustion engine 302 can operated in conjunction with a turbocharger 308. For example, the turbocharger 308 can be connected between an intake manifold 302A and an exhaust manifold 302B of the internal combustion engine 302. Turbochargers are forced induction devices used to increase the power output of an internal combustion engine. Turbochargers are well known in the art and therefore not discussed in further detail below. Additionally, the internal combustion engine 302 can be operated with an exhaust gas recirculation (EGR) loop. EGR involves recirculating at least a portion of the exhaust gas discharged from the exhaust manifold 302B of the internal combustion engine 302 to the intake manifold 302A of the internal combustion engine 302. The recirculating exhaust gas is mixed with air, for example, used in the combustion process of the internal combustion engine 302. The internal combustion engine 302 may require a predetermined ratio of recirculating exhaust gas to total intake gas. For example, the internal combustion engine 302 may require that the recirculating exhaust gas make up a maximum of 80% of the total intake gas (e.g., 80% recirculated exhaust gas and 20% air). The 80% recirculated exhaust gas to 20% air ratio is provided only as an example. A conventional low torque/RPM diesel engine, for example, can optionally require a maximum of 80% recirculated exhaust gas. This disclosure contemplates that the maximum percentage of recirculated exhaust gas required by an internal combustion engine can exceed 80% if practical. For example, the maximum percentage of recirculated exhaust gas can optionally be 85%, 90% or 95%, if practical.

Optionally, energy can be extracted from the recirculating exhaust gas. For example, a portion of the exhaust gas received at the exhaust gas manifold 302B of the internal combustion engine 302 can be diverted to a waste heat recovery system 304 (i.e., an energy extraction system). An EGR valve 306 can regulate/control an amount of exhaust gas that is diverted to the waste heat recovery system 304. Energy can then be extracted from the recirculating exhaust gas. Optionally, methods for extracting energy from cycle gas discussed in detail herein can be used to extract energy from the recirculating exhaust gas. After extracting energy, the recirculating exhaust gas can be returned to the intake manifold 302A of the internal combustion engine 302. An EGR mixing valve 310 can regulate/control the mixing of the recirculating exhaust gas with other intake gases (e.g., from the ambient atmosphere, from the turbocharger 308, etc.) As discussed above, a ratio of the recirculating exhaust gas to total intake gas at the intake manifold 302A can be a predetermined ratio required by the internal combustion engine 302. As discussed above, the internal combustion engine 302 may require that the recirculating exhaust gas make up a maximum of 80% of the total intake gas (e.g., 80% recirculated exhaust gas and 20% air). The 80% recirculated exhaust gas to 20% air ratio is provided only as an example. A conventional low torque/RPM diesel engine, for example, can optionally require a maximum of 80% recirculated exhaust gas. This disclosure contemplates that the maximum percentage of recirculated exhaust gas required by an internal combustion engine can exceed 80% if practical. For example, the maximum percentage of recirculated exhaust gas can optionally be 85%, 90% or 95%, if practical.

Similar to FIGS. 2A-2B, the waste heat recovery system 304 can include an expander 202, a heat exchanger 204 and a compressor 206. These components are the same or substantially similar to the components of FIGS. 2A-2B and are therefore not discussed in further detail below. Also similar to FIGS. 2A-2B, the cycle gas undergoes thermodynamic process A→B in the expander 202, thermodynamic process B→C in the heat exchanger 204 and thermodynamic process C→D in the compressor 206. These thermodynamic processes are therefore not discussed in further detail below. The recirculating exhaust gas from the internal combustion engine 302 can therefore be the cycle gas discussed above. The recirculating exhaust gas has an initial thermodynamic state (e.g., pressure, temperature, etc.) of exhaust gas discharged from the exhaust manifold 302B at point A. Alternatively or additionally, the recirculating exhaust gas after the thermodynamic processes discussed above can have a final thermodynamic state (e.g., pressure, temperature, etc.) of exhaust gas at the intake manifold 302A at point D as required by the internal combustion engine 302.

Optionally, the expander 202 and the compressor 206 can be mounted to a common shaft as discussed above. In this case, the net power output of the waste heat recovery system 304 is in mechanical form and is given by the difference between the mechanical power generated in the expander 202 and the mechanical power needed to perform the compression in the compressor 206. Alternatively, the waste heat recovery system 304 can include a motor-generator unit 230. For example, the expander 202 can power the motor-generator unit 230 such that it acts as an electric generator, which can supply power to the compressor 206 and/or an external system. Alternatively or additionally, the expander 202 and an electric generator can be mounted to a first shaft, and the compressor 206 and a motor can be mounted to a second shaft. In this case, the net output power, in electrical form, is given by the difference between the electrical power generated by the electric generator coupled to the expander 202 and the electrical power subtracted by the motor that actuates the compressor 206.

Optionally, the location of the EGR valve 306 can be optimized based on the characteristics of the specific internal combustion engine. For example, the EGR valve 306 can be disposed between the exhaust gas manifold 302B and the expander 202 (e.g., upstream of the expander 202) or between the expander 202 and the heat exchanger 204 (e.g., downstream of the expander 202 and upstream the heat exchanger 204) or between the heat exchanger 204 and the compressor 206 (e.g., downstream of heat exchanger 204 and upstream of the compressor 206) or between the compressor 206 and the intake manifold 302A (e.g., downstream of the compressor 206). As shown in FIG. 3, the EGR valve 306 is disposed upstream of the expander 202.

The waste heat recovery system for an internal combustion engine discussed above can provide the following advantages. First, it allows for recuperation and conversion the thermal energy carried by the exhaust gas of the EGR flow into useful mechanical work available at the shaft of the waste heat recovery system. Additionally, it allows for reduction of the backpressure (e.g., pressure in the exhaust manifold of the engine), which allows for an increase of the thermal conversion efficiency of the engine. Further, if the EGR valve is arranged downstream of the compressor, it allows for modulation of pressure upstream of the EGR valve by controlling the compressor speed through the motor/generator unit. This provides short-time “boost” in EGR flow, for instance, to better control residual fraction at the intake manifold during transient operations.

Example Calculations

An example of a first principle thermodynamic calculation is presented below in order to demonstrate the advantages provided by the open thermodynamic cycle discussed herein. The calculation shows some representative metrics of the cycle, for instance, net output power and overall thermodynamic efficiency. In the calculation, the following assumptions are introduced: (1) the pressure and temperature at point A are known, as well as with the fluid mass flow rate; (2) the final pressure at point D (e.g., atmospheric pressure) is imposed; (3) the temperature at point C (e.g., representing the lower limit of the cycle) is known; (4) the working fluid is air, with temperature-dependent specific heats; and (5) the compression and expansion processes are adiabatic and irreversible, with constant isentropic efficiency. The calculations have been carried out using the software ENGINEERING EQUATION SOLVER (EES) of F-CHART SOFTWARE, MADISON, Wis. The assumptions and calculations are presented below:

### Starting Data:

p₁=1.2 [bar] Inlet Pressure

T₁=870 [K] Inlet Temperature

m_{gas}=0.12 [kg/s] Gas Mass Flow Rate

Tₗᵢₘ=340 [K] Limit Temperature (in 3)

ηₜ=0.65 Turbine Efficiency

η_{c}=0.7 Compressor Efficiency

p₄=1 [bar] Final Pressure

### Calculate Theoretical Power Through Energy Definition:

Calculate Theoretical Power through Energy Definition

h₁=h(‘Air’, T=T₁)

s₁=s(‘Air’, P=p₁, T=T₁)

T₀=298 [K] Dead State Temperature

p₀=p₁ Dead State Temperature

pₜₕ=m_{gas}·(h₁−h(‘Air’, T=T₀)−T₀·(s(‘Air’, P=p₁, T=T₁)−s(‘Air’, P=p₀, T=T₀)))

### Calculate Power Obtained Through Simple Expansion (Turbine):

Calculate Power Obtained Through Simple Expansion (Turbine)

h₂₁=h₁−ηt(h₁−h(‘Air’, P=p₄, s=s₁))

p_{turbine}=m_{gas}·(h₁−h₂ₜ) Turbine Power

$${ɛ}_{t} = \frac{{P}_{turbine}}{{P}_{th}} \qquad Normalize by Availability$$

### Evaluate Performance of Heat Recovery System:

Evaluate Performance of Heat Recovery System

State 2—Expansion

p₂=0.75 [bar] End-Expansion Pressure—Can Be Optimized

h₂=h₁−η₁·(h₁−h(‘Air’, P=p₂, s=s₁))

T₂=T(‘Air’, h=h₂)

State 3—Cooling

p₃=p₂

T₃=Tₗᵢₘ

h₃=h(‘Air’, T=T₃)

s₃=s(‘Air’, P=p₃, T=T₃)

State 4—Compression

$${h}_{4} = {h}_{3} + \frac{1}{{η}_{c}} \cdot ( h ( ‘ Air ’ , P = {p}_{4} , s = {s}_{3} ) - {h}_{3} )$$

T₄=T(‘Air’, h=h₄)

### HRS Performance Summary:

HRS Performance Summary

Pₜ=m_{gas}·(h₁−h₂) Turbine Power

P_{c}=m_{gas}·(h₄−h₃) Compressor Power

Pₙₑₜ=Pₜ−P_{c} HRS Power

$${ɛ}_{HRS} = \frac{{P}_{net}}{{P}_{th}} \qquad Normalize by Availability$$

Q=m_{gas}·(h₂−h₃) Cooling Load

### SUMMARY OF RESULTS

| | | | |
|---|---|---|---|
| ε_{HRS} = 0.1115 | εₜ = 0.1075 | η_{c} = 0.7 H | ηₜ = 0.65 |
| h₁ = 899.7 [kJ/kg] | h₂ = 827.9 [kJ/kg] | h₂ₜ = 870.8 [kJ/kg] | h₃ = 340.7 [kJ/kg] |
| h₄ = 382.5 [kJ/kg] | m_{gas} = 0.12 [kg/s] | p₀ = 1.2 [bar] | p₁ = 1.2 [bar] |
| p₂ = 0.75 [bar] | p₃ = 0.75 [bar] | p₄ = 1 [bar] | P_{c} = 5.018 [kW] |
| Pₙₑₜ = 3.6 [kW] | Pₜ = 8.617 [kW] | Pₜₕ = 32.28 [kW] | P_{turbine} = 3.469 [kW] |
| Q = 58.47 {kW] | s₁ = 6.761 [kJ/kg-K] | s₃ = 5.914 [kJ/kg-K] | T₀ = 298 [K] |
| T₁ = 870 [K] | T₂ = 805.1 [K] | T₃ = 340 [K] | T₄ = 381.4 [K] |
| Tₗᵢₘ = 340 [K] | | | |

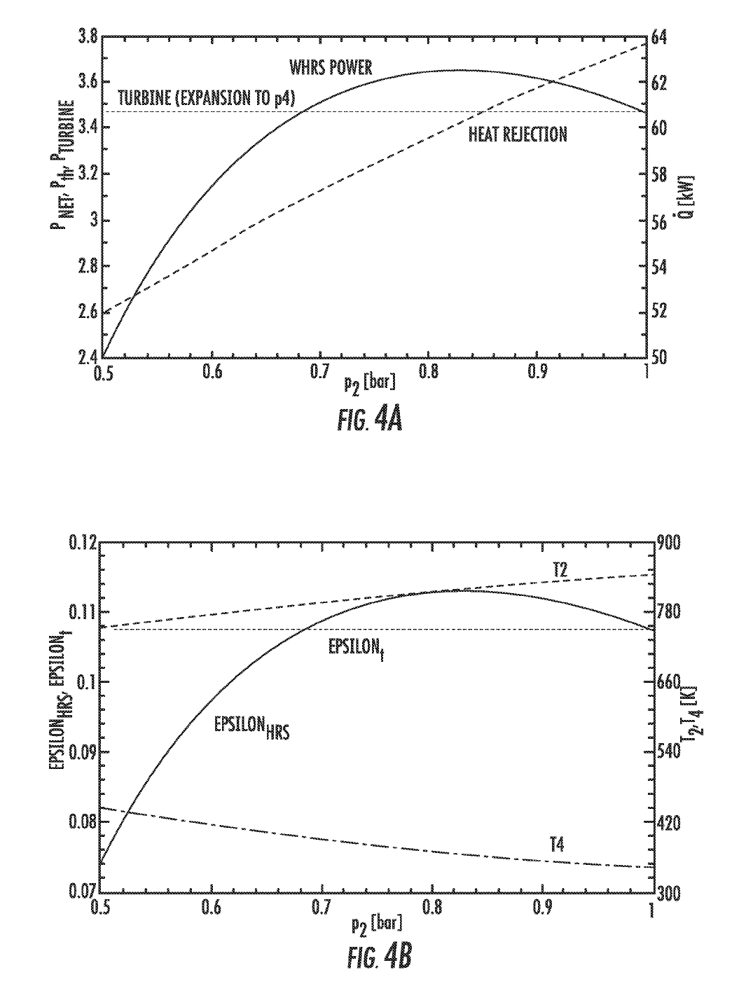

The above calculations show an example combination of assumptions. In order to show that there are opportunities for optimization in the open thermodynamic cycle, a sensitivity analysis in which, by leaving all other parameters constant (as above), the effect of varying the expander outlet pressure (p2) is shown in FIGS. 4A-4B. Specifically, FIG. 4A illustrates a sensitivity analysis of the effect of varying the expander outlet pressure (p2) on net output power (WHRS power) and heat rejection in thermodynamic process B→C (heat rejection). Additionally, FIG. 4B illustrates a sensitivity analysis of the effect of varying the expander outlet pressure (p2) on the efficiency of the cycle (epsilon_{HRS}), the efficiency of the expander (epsilonₜ), the expander outlet temperature (T2) and the compressor outlet temperature (T4).

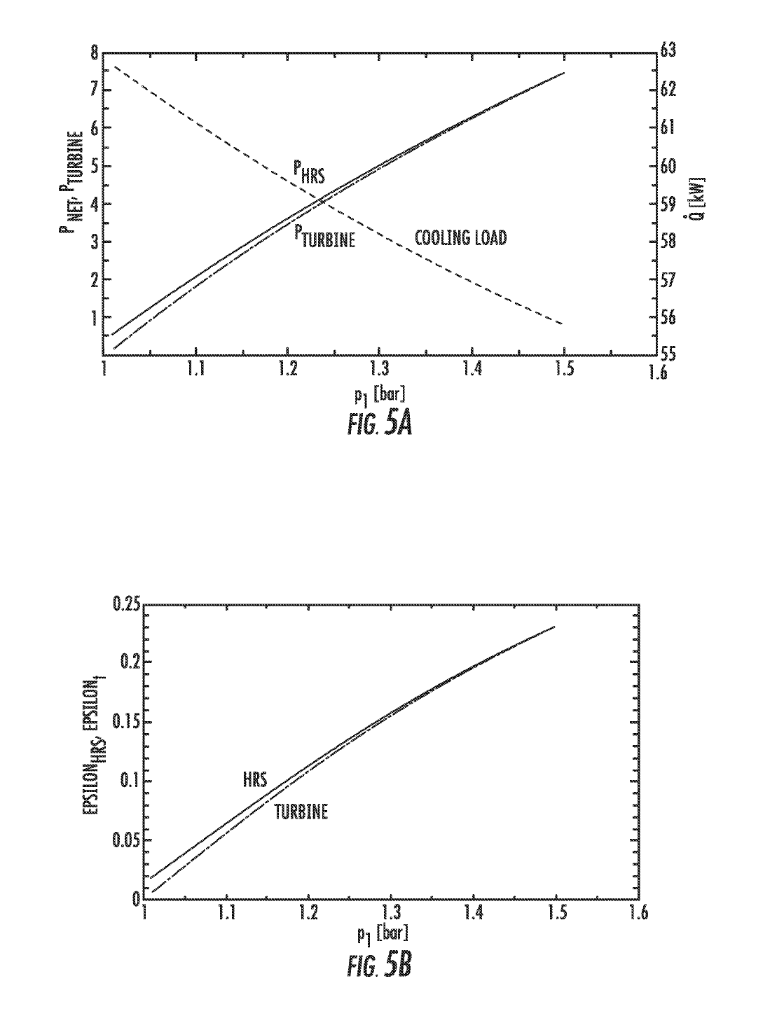

Additionally, another sensitivity analysis in which, by leaving all other parameters unvaried with p2=0.8 bar, the effect of varying the expander inlet pressure (p1) is shown in FIGS. 5A-5B. Specifically, FIG. 5A illustrates a sensitivity analysis of the effect of varying the expander inlet pressure (p1) on the expander power (P_{turbine}), the net power (Pₙₑₜ) and the heat rejection (cooling load). Additionally, FIG. 5B illustrates a sensitivity analysis of the effect of varying the expander inlet pressure (p1) on the efficiency of the cycle (epsilon_{HRS}) and the efficiency of the expander (epsilonₜ).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system for extracting energy from a cycle gas, comprising:
an expander for expanding the cycle gas;
a heat exchanger in fluid connection with the expander for cooling the expanded cycle gas while maintaining the expanded cycle gas at an approximately constant pressure; and
a compressor in fluid connection with the heat exchanger for compressing the cooled cycle gas.

2. The system of claim 1, wherein the cycle gas is expanded to a pressure less than ambient pressure, and wherein the cooled cycle gas is compressed to at least ambient pressure.

3. The system of claim 2, wherein a pressure of the cycle gas before expansion is greater than ambient pressure.

4. The system of claim 1, further comprising a common shaft, wherein the expander and the compressor are mounted to the common shaft.

5. The system of any of claims 1-4, wherein mechanical power generated by expanding the cycle gas is greater than mechanical power needed to compress the cooled cycle gas.

6. The system of any of claims 1-3, further comprising:
a first common shaft; and
an electric generator, wherein the expander and the electric generator are mounted to the first common shaft.

7. The system of claim 6, further comprising a power line in electrical communication with the electric generator for receiving electrical power.

8. The system of claim 7, wherein the received electrical power is DC electrical power, and the system further comprises a rectifier circuit for converting AC electrical power to the DC electrical power.

9. The system of any of claims 6-8, further comprising:
a second common shaft; and
a motor, wherein the compressor and the motor are mounted to the second common shaft.

10. The system of claim 9, further comprising a power line in electrical communication with the motor for supplying electrical power.

11. The system of claim 10, wherein the supplied electrical power is DC electrical power, and the system further comprises an inverter circuit for converting the DC electrical power to AC electrical power.

12. The system of claim 9, wherein electrical power generated by the electric generator is greater than electrical power needed to power the motor.

13. The system of claim 12, wherein net electrical power is supplied to an external system.

14. The system of any of claims 1-13, wherein expansion and compression of the cycle gas are polytropic processes.

15. The system of any of claims 1-13, wherein the expansion and compression of the cycle gas are adiabatic processes.

16. The system of any of claims 1-15, wherein the expander is a turbine or a volumetric expander.

17. The system of any of claims 1-16, wherein the heat exchanger is an air or liquid cooled heat exchanger.

18. The system of any of claims 1-17, wherein the cycle gas is a by-product exhaust gas of an upstream process.

19. A method for extracting energy from a cycle gas, comprising:
expanding the cycle gas in an expander;
cooling the expanded cycle gas in a heat exchanger while maintaining the expanded cycle gas at an approximately constant pressure; and
compressing the cooled cycle gas in a compressor.

20. The method of claim 19, wherein the cycle gas is expanded to a pressure less than ambient pressure, and wherein the cooled cycle gas is compressed to at least ambient pressure.

21. The method of claim 20, wherein a pressure of the cycle gas before expansion is greater than ambient pressure.

22. The method of any of claims 19-21, wherein mechanical power generated by expanding the cycle gas is greater than mechanical power needed to compress the cooled cycle gas.

23. The method of any of claims 19-22, further comprising driving an electric generator with the expander to produce electrical power.

24. The method of claim 23, further comprising converting the electrical power to DC electrical power.

25. The method of any of claims 23-24, further comprising:
supplying the electrical power to a motor; and
driving the compressor with the motor.

26. The method of claim 25, further comprising converting DC electrical power to the electrical power.

27. The method of claim 25, wherein electrical power generated by the electric generator is greater than electrical power needed to power the motor.

28. The method of any of claims 19-27, wherein expansion and compression of the cycle gas are polytropic processes.

29. The method of any of claims 19-27, wherein the expansion and compression of the cycle gas are adiabatic processes.

30. The method of any of claims 19-29, wherein the cycle gas is a by-product exhaust gas of an upstream process.

31. A system for extracting energy from an exhaust gas of an internal combustion engine, the internal combustion engine having an intake manifold and an exhaust manifold, comprising:
an expander in fluid connection with the exhaust manifold, the expander receiving and expanding at least a portion of the exhaust gas from the internal combustion engine;
a heat exchanger in fluid connection with the expander for cooling the expanded exhaust gas while maintaining the expanded exhaust gas at an approximately constant pressure; and
a compressor in fluid connection with the heat exchanger for compressing the cooled exhaust gas.

32. The system of claim 31, wherein the exhaust gas is expanded to a pressure less than ambient pressure, and wherein the cooled exhaust gas is compressed to at least ambient pressure.

33. The system of claim 32, wherein a pressure of the exhaust gas before expansion is greater than ambient pressure.

34. The system of claim 31, further comprising a common shaft, wherein the expander and the compressor are mounted to the common shaft.

35. The system of any of claims 31-34, wherein mechanical power generated by expanding the exhaust gas is greater than mechanical power needed to compress the cooled exhaust gas.

36. The system of claim 31, further comprising:
a first common shaft;
an electric generator, wherein the expander and the electric generator are mounted to the first common shaft;
a second common shaft; and
a motor, wherein the compressor and the motor are mounted to the second common shaft.

37. The system of claim 36, wherein electrical power generated by the electric generator is greater than electrical power needed to power the motor.

38. The system of claim 37, wherein net electrical power is supplied to an external system.

39. The system of claim 31, wherein the compressor is in fluid connection with the intake manifold, and wherein the compressed exhaust gas is discharged to the intake manifold.

40. The system of claim 39, wherein the expanded exhaust gas is cooled to a temperature required at the intake manifold.

41. The system of any of claims 39-40, further comprising an exhaust gas recirculation valve configured to regulate an amount of exhaust gas received by the expander.

42. The system of claim 41, wherein the exhaust gas recirculation valve is disposed between the exhaust gas manifold and the expander or between the expander and the heat exchanger or between the heat exchanger and the compressor or between the compressor and the intake manifold.

43. The system of any of claims 39-42, wherein a ratio of the compressed exhaust gas to total intake gas at the intake manifold is a predetermined ratio required by the internal combustion engine.

44. The system of claim 43, wherein the predetermined ratio is approximately 80% or less.

45. The system of any of claims 31-44, wherein a turbocharger is connected between the intake manifold and the exhaust manifold of the internal combustion engine, wherein at least a portion of the exhaust gas is received by the expander and the turbocharger.

46. A vehicle comprising:
an internal combustion engine having an intake manifold and an exhaust manifold; and
an exhaust gas recirculation system comprising:
an expander in fluid connection with the exhaust manifold, the expander receiving and expanding at least a portion of the exhaust gas from the internal combustion engine;
a heat exchanger in fluid connection with the expander for cooling the expanded exhaust gas while maintaining the expanded exhaust gas at an approximately constant pressure; and
a compressor in fluid connection with the heat exchanger for compressing the cooled exhaust gas, wherein the compressor is in fluid connection with the intake manifold, and wherein the compressed exhaust gas is discharged to the intake manifold.

47. The vehicle of claim 46, wherein the exhaust gas is expanded to a pressure less than ambient pressure, and wherein the cooled exhaust gas is compressed to at least ambient pressure.

48. The vehicle of claim 46, wherein a turbocharger is connected between the intake manifold and the exhaust manifold of the internal combustion engine, wherein at least a portion of the exhaust gas is received by the expander and the turbocharger.

49. A method for recirculating exhaust gas from an internal combustion engine, comprising:
receiving exhaust gas at an exhaust gas manifold of the internal combustion engine;
diverting at least a portion of the exhaust gas to an energy extraction system;
extracting energy from the diverted exhaust gas; and
returning the diverted exhaust gas to an intake manifold of the internal combustion engine, wherein a ratio of the returned exhaust gas to total intake gas at the intake manifold is a predetermined ratio required by the internal combustion engine.

50. The method of claim 49, wherein the predetermined ratio is approximately 80% or less.
